(19) United States
(12) Patent Application Publication
(10) Pub. No.: US 2004/0064612 A1
(43) Pub. Date: Apr. 1, 2004

(54) Method and system for using a memory card protocol inside a bus protocol

(75) Inventors: Yoseph Pinto, Palo Alto, CA (US); Micky Holtzman, Kfar Vradim (IL)

Correspondence Address: BEYER WEAVER & THOMAS LLP, P.O. BOX 778, BERKELEY, CA, 94704-0778, US

(73) Assignee: SanDisk Corporation

(21) Appl. No.: 10/256,689

(22) Filed: Sep. 26, 2002

(51) Int. Cl. G06F 12/00; G06F 12/14; G06F 12/16; G06F 13/00; G06F 13/28; G06F 13/42; G06F 13/14

(52) U.S. Cl. 710/105; 710/305

(57) ABSTRACT

A memory system (e.g., memory card) that is able to operate internally in accordance with a first protocol while communicating externally in a second protocol is disclosed. In one embodiment, a memory card operates in accordance with a memory card protocol (e.g., MMC) internally and communicates with a host over a bus protocol (e.g., I²C). As a result, communications between the memory card and the host can utilize the bus protocol by having the bus protocol include the memory card protocol. The memory system is typically a non-volatile memory product or device that provides binary or multi-state data storage.

### BACKGROUND OF THE INVENTION

1. Field of the Invention

The invention relates to a memory system for non-volatile data storage and, more particularly, to a memory system that facilitates use of different protocol standards.

2. Description of the Related Art

Electronic circuit cards, including memory cards, are commonly used to store digital data in a non-volatile manner for use with various products (e.g., electronic products). Examples of memory cards are flash cards that use Flash type or EEPROM type memory cells to store the data. Memory cards have a relatively small form factor and have been used to store digital data for products such as cameras, hand-held computers, mobile telephones, set-top boxes, game consoles, hand-held or other small audio players/recorders (e.g., MP3 devices), and medical monitors. A major supplier of flash cards is SanDisk Corporation of Sunnyvale, Calif.

Unfortunately, however, the development of the many different electronic circuit card and bus standards or protocols has created difficulties in providing compatibility. A memory card according to one standard or protocol is usually not usable with a host designed to operate with a card of another standard or protocol. Such incompatibilities lead to decreased usability of such electronic circuit cards and/or increased difficulty in supporting multiple different buses at hosts. Given the various electronic card standards, there are not only many differences in physical characteristics but also in the protocols used to send, store and retrieve data between electronic cards and hosts. Examples of several popular electronic card standards are briefly described below.

One electronic card standard, the PC Card Standard, provides specifications for three types of PC Cards. Originally released in 1990, the PC Card Standard now contemplates three forms of a rectangular card. An electrical connector, which engages pins of a slot in which the card is removably inserted, is provided along a narrow edge of the card. PC Card slots are included in current notebook personal computers, as well as in other host equipment, particularly portable devices. The PC Card Standard is a product of the Personal Computer Memory Card International Association (PCMCIA). The latest release of the PC Card Standard from the PCMCIA is dated February 1995, which standard is incorporated herein by this reference.

In 1994, SanDisk Corporation introduced the CompactFlash™ card (CF™ card) that is functionally compatible with the PC Card but is much smaller. The CF™ card is widely used with cameras for the storage of video data. A passive adapter card is available, in which the CF™ card fits, that then can be inserted into a PC Card slot of a host computer or other device. The controller within the CF™ card operates with the card's flash memory to provide an ATA interface at its connector. That is, a host with which a CF™ card is connected interfaces with the card as if it is a disk drive. Specifications for the card have been developed by the CompactFlash Association, a current version of these specifications being 1.4, which standard is incorporated herein by this reference.

The SmartMedia™ card is about one-third the size of a PC Card, and its specifications have been defined by the Solid State Floppy Disk Card (SSFDC) Forum, which began in 1996. The SmartMedia™ card is intended for use with portable electronic devices, particularly cameras and audio devices, for storing large amounts of data. A memory controller is included either in the host device or in an adapter card in another format such as one according to the PC Card standard. Physical and electrical specifications for the SmartMedia™ card have been issued by the SSFDC Forum, a current version of this standard being 1.0, which standard is incorporated herein by this reference.

Another non-volatile memory card is the MultiMediaCard (MMC™). The physical and electrical specifications for the MMC are given in “The MultiMediaCard System Specification” that is updated and published from time-to-time by the MultiMediaCard Association (MMCA). Version 3.1 of that Specification, dated June 2001, is expressly incorporated herein by this reference. MMC™ products having varying storage capacity up to 128 megabytes in a single card are currently available from SanDisk Corporation. The MMC™ card is rectangularly shaped with a size similar to that of a postage stamp. These products are described in a “MultiMediaCard Product Manual,” Revision 2, dated April 2000, published by SanDisk Corporation, which Manual is expressly incorporated herein by this reference. Certain aspects of the electrical operation of the MMC products are also described in U.S. Pat. No. 6,279,114 and in U.S. patent application Ser. No. 09/186,064, filed Nov. 4, 1998, both by applicants Thomas N. Toombs and Micky Holtzman, and assigned to SanDisk Corporation, and both of which are incorporated herein by reference.

A modified version of the MMC™ card is known as a Secure Digital (SD) card. The SD Card has the same rectangular size as the MMC card but with an increased thickness (2.1 mm.) in order to accommodate an additional memory chip when that is desired. A primary difference between these two cards is the inclusion in the SD card of security features for its use to store proprietary data such as that of music. Another difference between them is that the SD Card includes additional data contacts in order to enable faster data transfer between the card and a host. The other contacts of the SD Card are the same as those of the MMC™ card in order that sockets designed to accept the SD Card can also be made to accept the MMC™ card. This is described in U.S. patent application Ser. No. 09/641,023, filed by Cedar et al. on Aug. 17, 2000, which application is incorporated herein by this reference. The electrical interface with the SD card is further made to be, for the most part, backward compatible with the MMC™ card, in order that few changes to the operation of the host need be made in order to accommodate both types of cards. Specifications for the SD card are available to member companies from the SD Association (SDA).

Another type of memory card is the Subscriber Identity Module (SIM), the specifications of which are published by the European Telecommunications Standards Institute (ETSI). A portion of these specifications appear as GSM 11.11, a recent version being technical specification ETSI TS 100 977 V8.3.0 (2000-08), entitled “Digital Cellular Telecommunications System (Phase 2+); Specification of the Subscriber Identity Module—Mobile Equipment (SIM—ME) Interface,” (GSM 11.11 Version 8.3.0 Release 1999). This specification is hereby incorporated herein by this reference. Two types of SIM cards are specified: ID-1 SIM and Plug-in SIM.

The ID-1 SIM card has a format and layout according to the ISO/IEC 7810 and 7816 standards of the International Organization for Standardization (ISO) and the International Electrotechnical Commission (IEC). The ISO/IEC 7810 standard is entitled “Identification cards—Physical characteristics,” second edition, August 1995. The ISO/IEC 7816 standard has the general title of “Identification cards—Integrated Circuit(s) Cards with Contacts,” and consists of parts 1-10 that carry individual dates from 1994 through 2000. These standards, copies of which are available from the ISO/IEC in Geneva, Switzerland, are expressly incorporated herein by this reference. The ID-1 SIM card is generally the size of a credit card having rounder corners. Such a card may have only memory or may also include a microprocessor, the latter often being referred to as a “Smart Card.” One application of a Smart Card is as a debit card where an initial credit balance is decreased every time it is used to purchase a product or a service.

The Plug-in SIM is a very small card, smaller than the MMC™ and SD cards. The GSM 11.11 specification referenced above calls for this card to be a rectangle 25 mm. by 15 mm., with one corner cut off for orientation, and with the same thickness as the ID-1 SIM card. A primary use of the Plug-in SIM card is in mobile telephones and other portable devices. In both types of cards including the SIM, eight electrical contacts (but with as few as five being used) are specified in the ISO/IEC 7816 standard to be arranged on a surface of the card for contact by a host receptacle.

Sony Corporation developed a non-volatile memory card, sold as the Memory Stick™ that has yet another set of specifications. Its shape is that of an elongated rectangle having electrical contacts on a surface adjacent one of its short sides. The electrical interface through these contacts with a host to which it is connected is unique.

As is apparent from the foregoing summary of the primary electronic card standards, there are many differences in their physical characteristics including size and shape, in the number, arrangement and structure of electrical contacts and in the electrical interface with a host system through those contacts when the card is inserted into the host card slot. Adapters, both active and passive types, allow some degree of interchangeability of electronic cards among such host devices.

There are also various bus standards or protocols. One bus protocol, the I²C standard, provides data communication between a controller and peripheral devices or integrated circuits (e.g., memory, peripheral controller, etc.). I²C uses two active wires to provide the data communication. Other bus protocols often used with peripheral devices are Universal Serial Bus (USB) and FireWire. There are various differences amongst the different bus standards. Further, these bus standards are mainly designed for peripheral or inter-chip communications, not necessarily for communications with electronic cards.

Thus, there is a need for improved approaches to overcome some of the incompatibilities between differing standards and protocols for electronic cards.

### SUMMARY OF THE INVENTION

Broadly speaking, the invention relates to a memory system (e.g., memory card) that is able to operate internally in accordance with a first protocol while communicating externally in a second protocol. In one embodiment of the invention, a memory card operates in accordance with a memory card protocol (e.g., MMC) internally and communicates with a host over a bus protocol (e.g., I²C). As a result, communications between the memory card and the host can utilize the bus protocol by having the bus protocol include the memory card protocol. The memory system is typically a non-volatile memory product or device that provides binary or multistate data storage.

The invention can be implemented in numerous ways. For example, the invention can be implemented as a system, device or method. Several embodiments of the invention are discussed below.

As a memory system that stores data and is controlled by a host that couples to the memory system via a host bus, one embodiment of the invention includes at least a plurality of memory blocks and a memory controller. Each of the memory blocks include at least a plurality of data storage elements. The memory controller operates to internally perform read and write operations with respect to the data storage elements for the host in accordance with a first protocol, and said memory controller operates to externally communicate over the host bus in accordance with a second protocol.

As a method for communicating electronic signals representative of data or commands over a bus coupled between a host and a memory card, one embodiment of the invention includes at least the acts of: receiving an incoming envelope at the memory card over the bus in accordance with a bus protocol, the incoming envelope including at least incoming data or commands in accordance with a memory card protocol; removing the incoming envelope to retain the incoming data or commands; and thereafter processing the incoming data or commands at the memory card in accordance with the memory card protocol.

As a method for transmitting information between a peripheral device and a bus associated with a computing device, one embodiment of the invention includes at least the acts of: obtaining information to transmit, the information obtained being associated with a first protocol; adapting the information obtained for transmission in a second protocol; and transmitting the adapted information over the bus using the second protocol.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a computing system according to one embodiment of the invention.

FIG. 2 is a block diagram of a memory card controller according to one embodiment of the invention.

FIG. 3 is a flow diagram of information transmission processing according to one embodiment of the invention.

FIG. 4 is a flow diagram of card information processing according to one embodiment of the invention.

FIGS. 5A and 5B illustrate an example of a MMC read command provided within a I²C protocol.

FIGS. 6A-6E illustrate an example of a MMC write multiple block command provided within a I²C protocol.

FIG. 7 is a block diagram of an envelope unit according to one embodiment of the invention.

### DETAILED DESCRIPTION OF THE INVENTION

The invention relates to a memory system (e.g., memory card) that is able to operate internally in accordance with a first protocol while communicating externally in a second protocol. In one embodiment of the invention, a memory card operates in accordance with a memory card protocol (e.g., MMC) internally and communicates with a host over a bus protocol (e.g., I²C). As a result, communications between the memory card and the host can utilize the bus protocol by having the bus protocol include the memory card protocol. The memory system is typically a non-volatile memory product or device that provides binary or multistate data storage.

The memory system can, for example, be associated with a memory card (such as a plug-in card), a memory stick, or some other semiconductor memory product. Examples of memory cards include PC Card (formerly PCMCIA device), Flash Card, Flash Disk, Multimedia Card, and ATA Card.

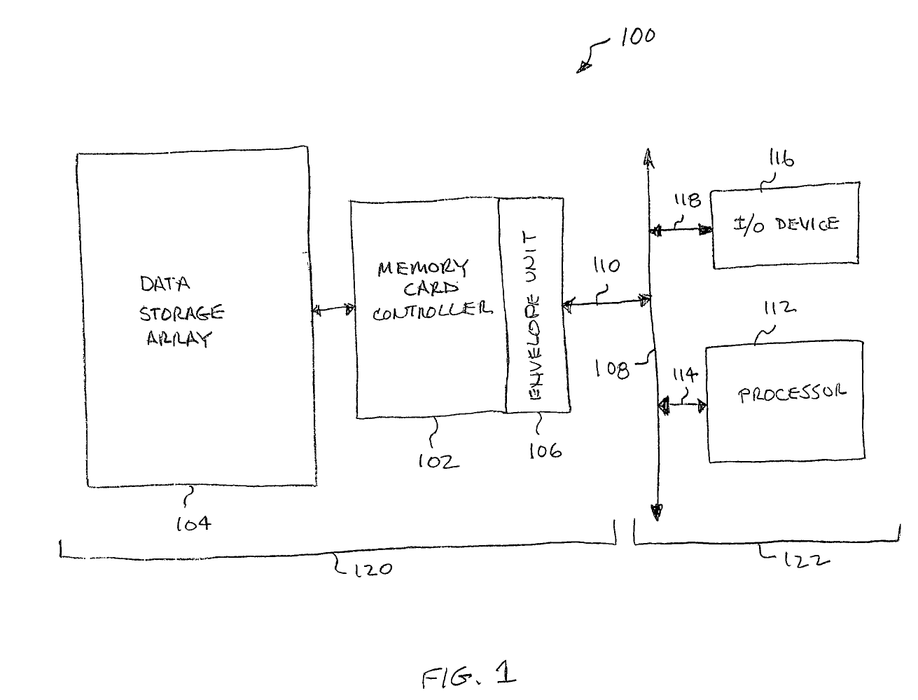

Embodiments of this aspect of the invention are discussed below with reference to FIGS. 1 through 7. However, those skilled in the art will readily appreciate that the detailed description given herein with respect to these figures is for explanatory purposes as the invention extends beyond these limited embodiments.

FIG. 1 is a block diagram of a computing system 100 according to one embodiment of the invention. The computing system 100 includes a memory card controller 102 that couples to a data storage array 104. The data storage array 104 provides storage for a relatively large amount of data. The storage provided by the data storage array 104 is typically non-volatile data storage. In one embodiment, the data storage array 104 is arranged to include a plurality of memory blocks that together comprise the data storage array 104. The computing system 100 also includes an envelope unit 106. The envelope unit 106 couples between the memory card controller 102 and a peripheral bus 108. A link 110 couples the peripheral bus 108 to the envelope unit 106 and/or the memory card controller 102. In addition, a processor 112 couples to the peripheral bus 108 over a link 114 and an Input/Output (I/O) device 116 couples to the peripheral bus 108 over a link 118.

The computing system 100 can be considered as a combination of a memory system 120 and a host system 122. The memory system 120 includes the memory card controller 102, the data storage array 104 and the envelope unit 106. The host system 122 includes the peripheral bus 108, the processor 112 and the I/O device 116. In other words, the memory system 120 can be considered a peripheral to the host system 122.

In any case, the memory card controller 102 controls access to the data storage array 104. Hence, the memory card controller 102 can interact with the data storage array 104 to provide non-volatile storage. In this regard, the memory card controller 102 can read, program or erase data to the data storage array 104. The memory card controller 102 interacts with the host system 122 to receive data from or supply data to the data storage array 104. According to one embodiment of the invention, the envelope unit 106 is provided between the memory card controller 102 and the peripheral bus 108. The envelope unit 106 serves to enable the memory card controller 102 to communicate with the data storage array 104 using a first protocol (e.g., memory card protocol), while also enabling communications between the memory system 120 and the host system 122 using a second protocol (e.g., bus protocol). In one implementation, the envelope unit 106 is part of the memory card controller 102. In another embodiment, the envelope unit 106 is separate from the memory card controller 102.

Typically, the memory card controller 102 operates in accordance with a particular protocol, such as MultiMedia Card (MMC) protocol or Secure Device (SD) protocol. However, since these protocols are developed specifically for memory card applications, they are often not used elsewhere. In contrast, the protocol used over the peripheral bus 108 tends to be a more general use protocol for communications over a bus. For example, one common peripheral bus protocol is referred to as I²C. Another common peripheral bus protocol is Universal Serial Bus (USB).

Consider an implementation in which the I/O device 116 and the processor 112 are able to send or receive data over the peripheral bus 108 using the I²C protocol and the memory card controller 102 understands the MMC protocol. The I/O device 116 and the processor 112 normally make use of drivers to communicate over the peripheral bus 108 using the I²C protocol. However, the memory card controller 102 is not able to understand the I²C protocol. In other words, the I²C protocol is not suitable for use by the memory card controller 102.

Thankfully, according to the invention, the host is able to communicate over the peripheral bus 108 to the memory card controller 102 by transmitting or receiving data in accordance with the I²C protocol. However, the use of the I²C protocol over the peripheral bus 108 contains or includes commands and data in accordance with a different protocol (e.g., MMC or SD) that is understood by the memory card controller 102.

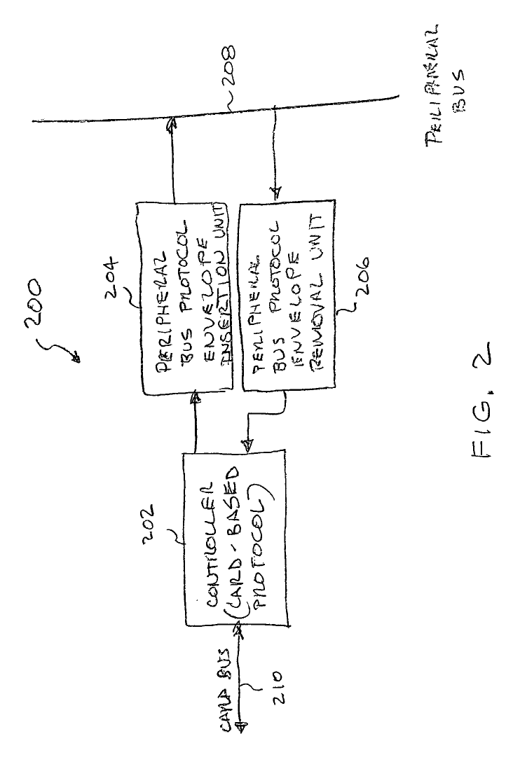

FIG. 2 is a block diagram of a memory card controller 200 according to one embodiment of the invention. The memory card controller 200 includes a controller 202 that operates in accordance with a card-based protocol. The memory card controller 200 also includes a peripheral bus protocol envelope insertion unit 204 and a peripheral bus protocol envelope removal unit 206. The memory card controller 200 is provided between a peripheral bus 208 and a card bus 210. The peripheral bus 208 couples to and is utilized by peripherals and a host (e.g., host system 122). The card bus 210 couples to and is utilized by a data storage array (e.g., data storage array 104). The card bus 210 operates in accordance with the card-based protocol, while the peripheral bus 208 operates in accordance with the peripheral bus protocol. However, according to the invention, the peripheral bus 208 can carry an envelope in accordance with the peripheral bus protocol, but within the envelope the card-based protocol is utilized. Hence, when the host transmits control and data signals over the peripheral bus 208 to the controller 202, the incoming envelope in accordance with the peripheral bus protocol is processed by the peripheral bus protocol envelope removal unit 206 to remove the envelope so as to expose the card-based protocol. The controller 202 then operates in accordance with the data and control signals specified by the card-based protocol. On the other hand, when the controller 202 sends data or control signals to the host, the peripheral bus protocol envelope insertion unit 204 provides an envelope around the card-based protocol for the data and control signals, such that once enveloped, the data and control signals can be transmitted over the peripheral bus 208 in accordance with the peripheral bus protocol.

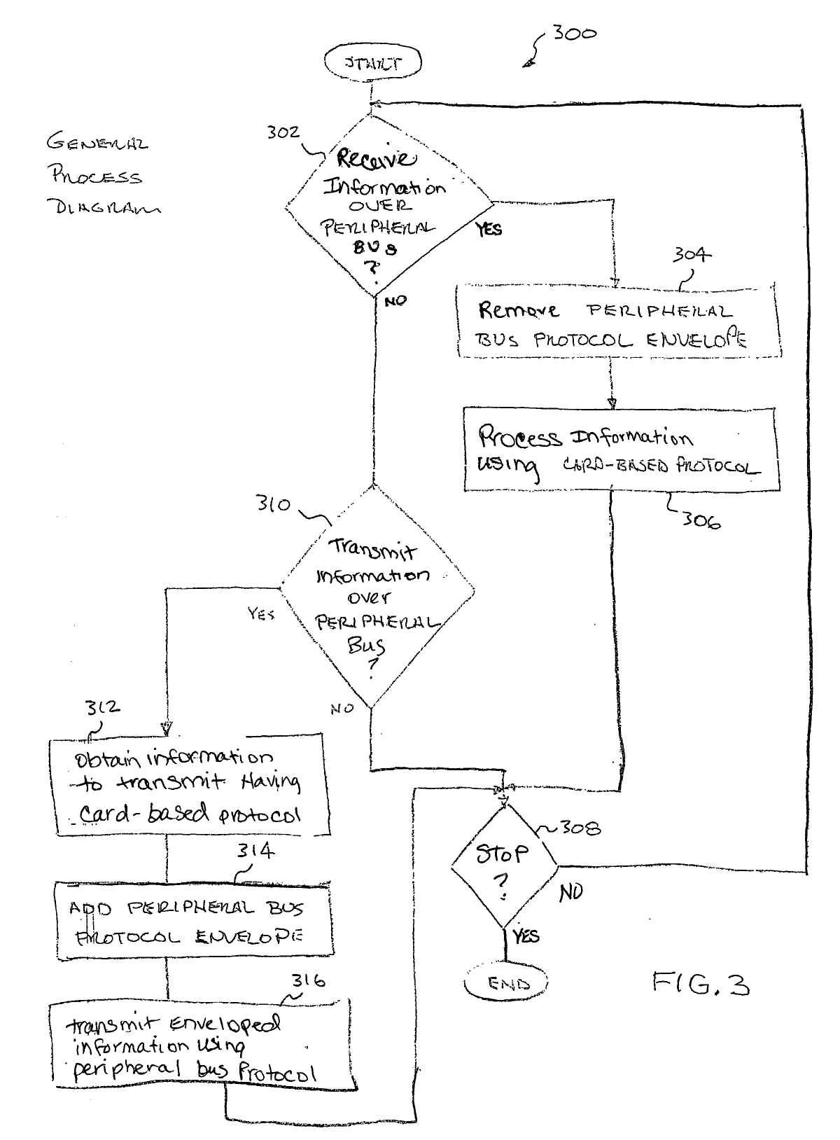

FIG. 3 is a flow diagram of information transmission processing 300 according to one embodiment of the invention. The information transmission processing 300 is, for example, performed by the memory system 120 shown in FIG. 1 or the memory card controller 200 shown in FIG. 2.

The information transmission processing 300 begins with a decision 302 that determines whether information has been received over a peripheral bus Here, a memory controller coupled to the peripheral bus would determine whether such information has been received over the peripheral bus. When the decision 302 determines that information has been received over the peripheral bus, a peripheral bus protocol envelope in which the information was transmitted is removed 304. Here, note that the information was transmitted over the peripheral bus using the peripheral bus protocol. More particularly, the information was packaged in a peripheral bus protocol envelope such that transmission could occur over the peripheral bus. However, at the memory controller, the peripheral bus protocol envelope is removed 304. Thereafter, the information is processed 306 at the memory controller using a card-based protocol. In other words, at the memory controller, the information is processed in accordance with the protocol associated with the memory card, such as MMC or SD Card protocols.

On the other hand, when the decision 302 determines that information has not been received over the peripheral bus, then a decision 310 determines whether information is to be transmitted over the peripheral bus. When the decision 300 determines that information is to be transmitted over the peripheral bus, then the information to be transmitted is obtained 312. Since the information is obtained from the memory controller, the information, as obtained 312, has the card-based protocol. Hence, a peripheral bus protocol envelope is then added 314. Here, the peripheral bus protocol envelope is provided around the information to be transmitted having the card-based protocol. Hence, the envelope itself utilizes the peripheral bus protocol. Thereafter, the enveloped information can be transmitted 316 using the peripheral bus protocol.

Following the operation 306 as well as following the operation 316, a decision 308 determines whether the information transmission processing 300 should stop. When the decision 308 determines that the information transmission processing 300 should not stop, then the information transmission processing 300 returns to repeat the decision 302 and subsequent operations so that additional information can be received or transmitted to or from the memory card controller. On the other hand, when the decision 308 determines that the information transmission processing 300 should stop, then the information transmission processing 300 is complete and ends.

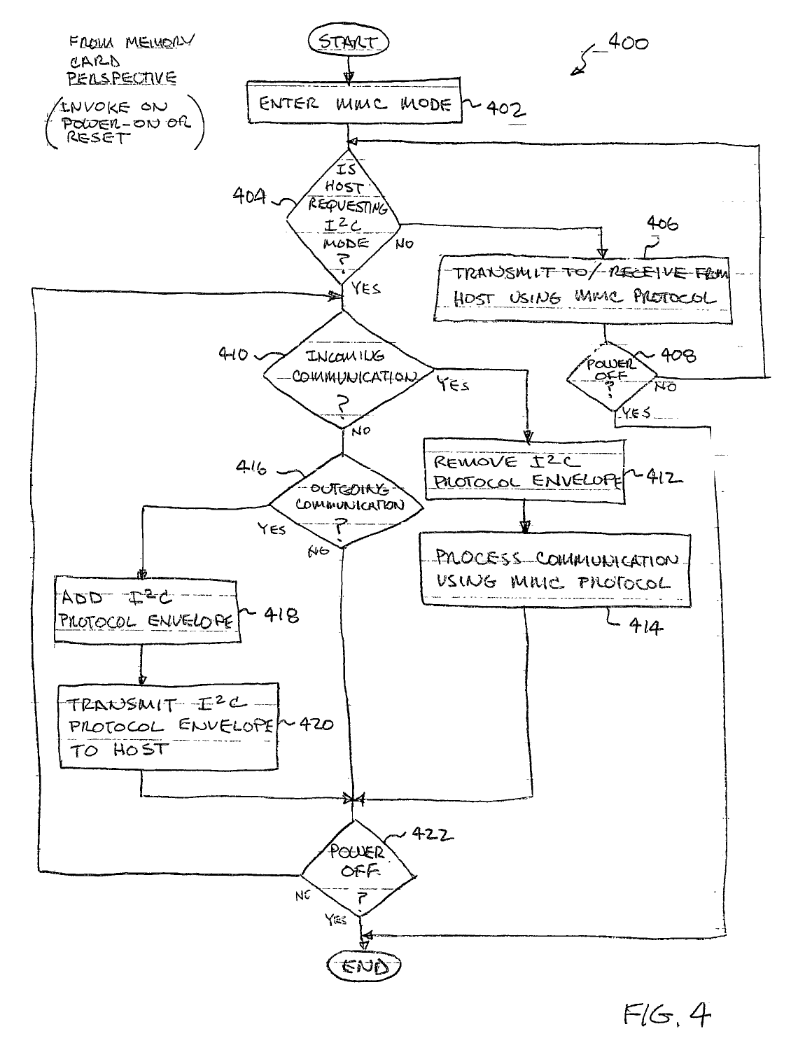

FIG. 4 is a flow diagram of card information processing 400 according to one embodiment of the invention. The card information processing 400 is, for example, performed by a memory card controller. For example, the memory controller can be the memory card controller 102 shown in FIG. 1 or the controller 202 shown in FIG. 2. In one embodiment, the card information processing 400 is processing performed by the memory card controller together with an envelope unit that may or may not be integral or provided on the same integrated circuit (e.g., chip) as the memory card controller.

The card information processing 400 initially enters 402 a MMC mode. For example, when the memory card having the memory card controller therein is powered-on or reset, the memory card initially enters 402 the MMC mode. Next, a decision 404 determines whether a host operatively connected to the memory card is requesting an I²C mode. When the decision 404 determines that the host is not requesting I²C mode, then information can be transmitted to or received from 406 the host using the MMC protocol. Here, the host understands the MMC protocol and thus the memory card is able to transmit information to or receive information from the host through a special port or properly configured port. Likewise, when the peripheral bus utilizes the MMC protocol, the memory card is able to receive information using the MMC protocol. Following the operation 406, a decision 408 determines whether the memory system should be powered-off. The host system might close the peripheral bus on power-down. Such power down could, for example, be initiated on power-down of the host system itself or on removal of the memory card from the memory system 120. When the decision 408 determines that the memory system should not be powered-off, then the processing returns to repeat the decision 404 and subsequent operations.

On the other hand, when the decision 404 determines that the host is requesting the I²C mode, then a decision 410 determines whether the memory card is receiving an incoming communication. When the decision 410 determines that the memory card is receiving an incoming communication, then an I²C protocol envelope is removed 412. Here, the incoming communication is packaged in an I²C protocol envelope, and thus the removal 412 of the I²C protocol envelope is performed. Thereafter, the communication can be processed 414 using the MMC protocol.

Alternatively, when the decision 410 determines that there is no incoming communication, then a decision 416 determines whether there is an outgoing communication. When the decision 416 determines that there is an outgoing communication, an I²C protocol envelope is added 418 to the outgoing communication. Here, the outgoing communication provided by the memory card is in accordance with the MMC protocol. Hence, by adding 418 the I²C envelope around the outgoing communication, the outgoing communication is then able to be transmitted 420 to the host using the I²C protocol envelope.

Following the operations 414, 416 and 420, the communication, if any, has been processed. Hence, following the operation 414 when there is an incoming communication, following the operation 420 when there is an outgoing communication or following 416 when there is neither an incoming nor outgoing communication, a decision 422 determines whether the memory system should be powered-off. When the decision 422 determines that the memory system should not be powered-off, then the card information processing 400 returns to repeat the decision 410 and subsequent operations. On the other hand, when the decision 422 determines that the memory system should be powered-off, as well as following the decision 408 when the memory system is to be powered-off, the card information processing 400 is complete and ends.

The host system might close the peripheral bus on power-down of the memory system. Such power down could, for example, be initiated on power-down of the host system itself or on removal of the memory card from the memory system.

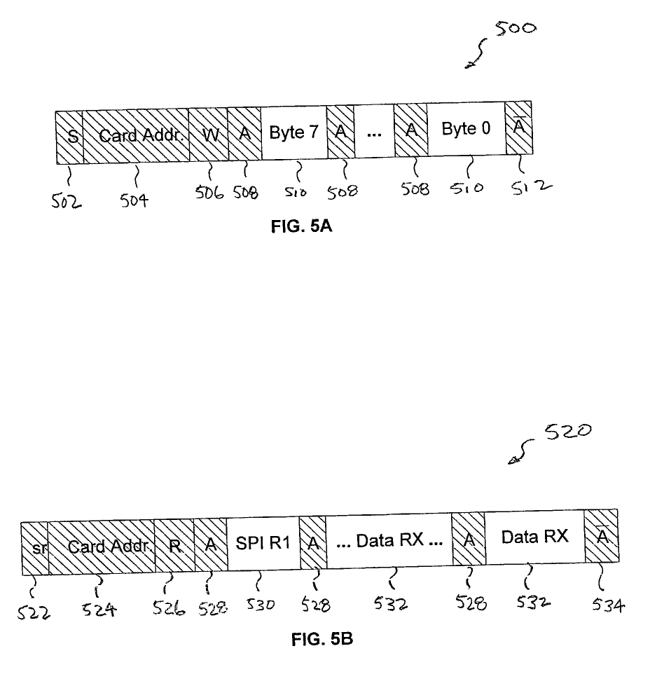

FIGS. 5A and 5B illustrate an example of a MMC read command provided within a I²C protocol. The MMC protocol being utilized within the I²C protocol is the SPI mode of MMC. FIG. 5A depicts a I²C frame 500 that is transmitted over a peripheral bus by a host to a memory card controller. The I²C frame 500 conforms to the I²C protocol, yet includes a MMC read command. The I²C frame 500 includes a start field (S) 502, a card address field 504, a write command field (W) 506, acknowledgement fields (A) 508, data fields 510 and stop field (/A) 512. The data fields 510 embed the MMC read command. The MMC read command would, for example, include a start bit, a command, arguments, cyclic redundancy code and a stop bit. The fields 502-508 and 512 pertain to the I²C protocol and the fields 510 pertain to the MMC protocol. Hence, the MMC protocol is enveloped by the I²C protocol.

FIG. 5B depicts a I²C frame 520 that is transmitted over the peripheral bus from the memory card controller to a host. The I²C frame 520 conforms to the I²C protocol, yet includes a response the MMC read command included in the I²C frame 500. The I²C frame 520 includes a start response field (sr) 522, a card address field 524, a read command field (R) 526, acknowledgement fields (A) 528, a SPI command 530, data fields 532, and a stop field (/A) 534. The data fields 510 embed the MMC read command. The data fields 532 include the responsive data to the read command. The fields 522-528 and 534 pertain to the I²C protocol and the fields 530 and 532 pertain to the MMC protocol. Hence, the MMC protocol is again enveloped by the I²C protocol.

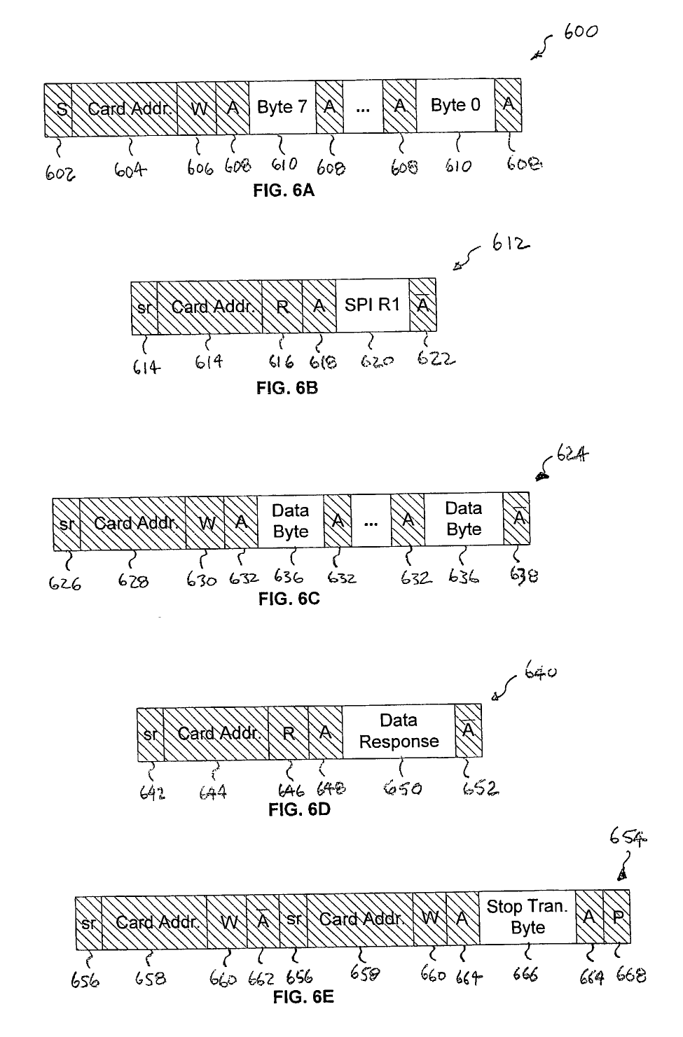

FIGS. 6A-6E illustrate an example of a MMC write multiple block command provided within a I²C protocol. The MMC protocol being utilized within the I²C protocol is the SPI mode of MMC. FIG. 6A depicts a I²C frame 600 that is transmitted over a peripheral bus by a host to a memory card controller. The I²C frame 600 conforms to the I²C protocol, yet includes a MMC write command. The I²C frame 600 includes a start field (S) 602, a card address field 604, a write command field (W) 606, acknowledgement fields (A) 608, and data fields 610. The data fields 610 embed the MMC write command. The MMC write command would, for example, include a start bit, a command, arguments, cyclic redundancy code and a stop bit. The fields 602-608 pertain to the I²C protocol and the fields 610 pertain to the MMC protocol. Hence, the MMC protocol is enveloped by the I²C protocol.

FIG. 6B depicts a I²C frame 612 that is transmitted over the peripheral bus from the memory card controller to a host. The I²C frame 612 conforms to the I²C protocol, yet includes a response to the MMC write command included in the I²C frame 500. Here, the response to the MMC write command informs the host that the memory controller is ready to receive the write data. The I²C frame 612 includes a start response field (sr) 614, a card address field 614, a read command field (R) 616, acknowledgement fields (A) 618, a SPI command 620, and stop field (/A) 622. The fields 614-618 and 622 pertain to the I²C protocol and the field 620 pertains to the MMC protocol. Hence, the MMC protocol is again enveloped by the I²C protocol.

FIG. 6C depicts a I²C frame 624 that is transmitted over the peripheral bus from the memory card controller to a host. The I²C frame 624 conforms to the I²C protocol, yet includes data to be written to a memory card by the MMC write command included in the I²C frame 600 (FIG. 6A). The I²C frame 624 includes a start response field (sr) 626, a card address field 628, a write command field (W) 630, acknowledgement fields (A) 632, data fields 636, and a stop field (/A) 638. The data fields 636 embed the data being written to the memory card. The fields 626-632 and 638 pertain to the I²C protocol and the fields 636 pertain to the MMC protocol. Hence, the MMC protocol is again enveloped by the I²C protocol.

FIG. 6D depicts a I²C frame 640 that is transmitted over the peripheral bus from the memory card controller to a host. The I²C frame 640 conforms to the I²C protocol, yet includes a response to the data written to the memory card by the I²C frame 624. The I²C frame 640 includes a start response field (sr) 642, a card address field 644, a read command field (R) 646, an acknowledgement field (A) 648, a data response 650, and a stop field (/A) 652. The fields 642-648 and 652 pertain to the I²C protocol and the field 650 pertains to the MMC protocol. Hence, the MMC protocol is again enveloped by the I²C protocol.

FIG. 6E depicts a I²C frame 654 that is transmitted over the peripheral bus from the memory card controller to a host. The I²C frame 654 conforms to the I²C protocol, yet includes a command that informs the memory card that the MMC write command initiated by the I²C frame 600 (FIG. 6A) is now completed. The I²C frame 654 includes start response fields (sr) 656, card address fields 658, write command fields (W) 660, a stop field (/A) 662, acknowledgement fields (A) 664, a stop transmission field 666, and a I²C,s “P” field (P) 668. The fields 656-664 and 668 pertain to the I²C protocol and the field 666 pertains to the MMC protocol. Hence, the MMC protocol is again enveloped by the I²C protocol.

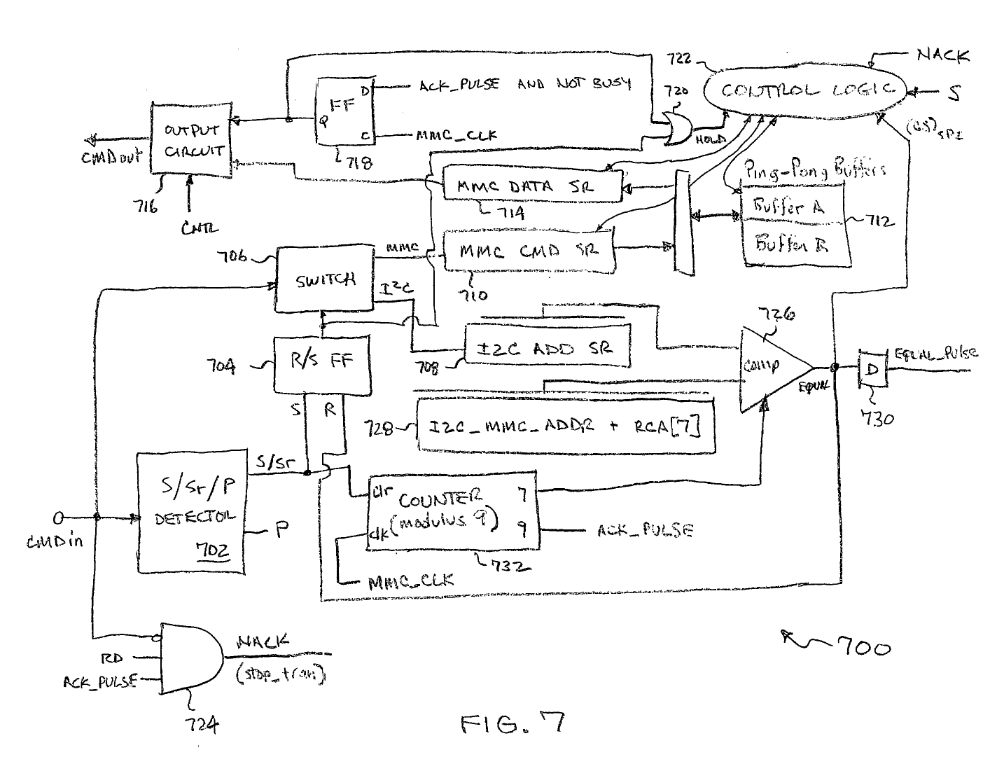

FIG. 7 is a block diagram of an envelope unit 700 according to one embodiment of the invention. The envelope unit 700 is, for example, one detailed implementation suitable for use as the envelope unit 106 illustrated in FIG. 1.

The envelope unit 700 receives a command in (CMDin) in accordance with the I²C protocol. The CMDin is supplied to a S/Sr/P detector 702. When the detector 702 detects the start bit (S/Sr), a R/S flip-flop 704 is set. The output of the flip-flop 704 is supplied to a switch 706. When the output of the flip-flop 704 is set, the switch 706 directs the CMDin to a I²C address shift register 708. On the other hand, when the output of the flip-flop 704 is reset, the switch 706 directs the CMDin to a MMC command shift register 710. Hence, the shift register 708 stores the I²C address, while the shift register 710 stores the MMC command being enveloped by the I²C protocol.

The shift register 710 can couple with ping-pong buffers 712 (e.g., buffers A and B) to provide temporary buffering of the MMC command. A MMC data shift register 714 also couples to the ping-pong buffers 712 and/or the shift register 710. The MMC data shift register 714 couples to an output circuit 716. A flip-flop 718 supplies a ready signal to the output circuit 716 based on an acknowledgement signal (Ack_Pulse) and a MMC clock (MMC_CLK). The output circuit 716 also receives a control signal (CNTL). The output circuit 716 produces an output command (CMDout). The ready signal produced by the flip-flop 718 is also supplied to OR gate 720. In addition, the OR gate 720 receives the output of the flip-flop 704. The output of the OR gate 720 is a hold signal (HOLD) that is supplied to control logic 722 so that the internal state of the MMC-SPI within the memory card controller is frozen during the I²C envelope handling processing.

The control logic 722 also receives a negative acknowledgement (NACK, or stop transmission signal) from an AND gate 724. Still further, the control logic 722 receives a start indication (S) from the detector 702 and an equal signal (EQUAL) provided by the comparator 726 that compares the addresses from the shift registers 708 and 728 to produce the equal signal (EQUAL). Still further, the control logic 722 is coupled to the shift registers 710 and 714 as well as the ping-pong buffers 712. A delay circuit (D) 730 can delay the equal signal (EQUAL) to produce an Equal_Pulse.

The counter 732 receives the start bit indication from the detector 702 and the MMC_clock (MMC_CLK). The counter 732 produces a pulse at count 7 to cause the comparator 726 to activate and a count 9 to produce the acknowledgement signal (Ack_Pulse). The acknowledgement signal (Ack_Pulse) is generated for the response to the host that supplied the CMDin. When the comparator 726 determines that the addresses-are equal, the command that has been received is thus determined to be directed to the particular memory card performing such processing. Consequently, the equal signal (EQUAL) is supplied to the flip-flop 704 to cause a reset operation. This, in turn, causes the hold by the OR gate 720 to be released and directs the CMDin to the MMC command shift register 710, thus supplying the MMC command embedded within the I²C protocol to the MMC-SPI engine inside the memory card controller. The equal signal (EQUAL) can also produce an internal chip select signal (CS_{SPI}) which can be asserted so the MMC-SPI engine understands that this particular memory card is selected. The only signal that closes the I²C envelope in the output direction is the acknowledgement bit (A) which is forced to 1 when the memory card is busy, otherwise the acknowledgement bit (A) remains at “1”. The flip-flop 718 serves to force the acknowledgement bit (A) to 0 when appropriate. The control signal (CNTL) selects whether the MMC protocol or an acknowledgement signal (I²C protocol) are output.

Although much of the discussion of the invention provided above pertains to multi-state devices, it should be understood that the invention is also applicable to binary storage devices. Multi-state devices do, however, provide greater storage density than binary storage devices.

The invention can further pertain to an electronic system that includes a memory system as discussed above. Memory systems (i.e., memory cards) are commonly used to store digital data for use with various electronic products. Often, the memory system is removable from the electronic system so that the stored digital data is portable. The memory systems according to the invention can have a relatively small form factor and be used to store digital data for electronic products such as cameras, hand-held or notebook computers, network cards, network appliances, set-top boxes, hand-held or other small audio players/recorders (e.g., MP3 devices), and medical monitors.

The advantages of the invention are numerous. Different embodiments or implementations may yield one or more of the following advantages. One advantage of the invention is that memory cards are able to be used with hosts or peripherals buses that use commonly-used peripheral bus protocols. Conventionally, commonly-used peripheral bus protocols are not able to be used with memory cards because the standards and protocols for memory cards tend to be different from the memory card protocols. In one implementation, a hardware layer of a second protocol (e.g., bus protocol) is used together with higher layers of a first protocol (e.g., memory card protocol). Another advantage of the invention is that a memory card system is able to be compatible with more host systems. For example, a memory card can be used not only with host systems that directly support memory card protocols but also with host systems that support bus protocols. Hence, depending on which of the types of host systems the memory card is coupled to (e.g., inserted), the memory card is also to function properly.

The many features and advantages of the present invention are apparent from the written description and, thus, it is intended by the appended claims to cover all such features and advantages of the invention. Further, since numerous modifications and changes will readily occur to those skilled in the art, the invention should not be deemed limited to the exact construction and operation as illustrated and described. Hence, all suitable modifications and equivalents are included within the scope of the invention.

What is claimed is:

1. A memory system that stores data and is controlled by a host that couples to said memory system via a host bus, said memory system comprising:
a plurality of memory blocks, each of said memory blocks including at least a plurality of data storage elements; and
a memory controller operatively coupled to said memory blocks and operatively coupleable to the host via the host bus, said memory controller operating to internally perform read and write operations with respect to the data storage elements for the host in accordance with a first protocol, and said memory controller operating to externally communicate over the host bus in accordance with a second protocol.

2. A memory system as recited in claim 1, wherein the read and write operations are performed with respect to the data storage elements for the host.

3. A memory system as recited in claim 1, wherein said memory controller adds an envelope in accordance with the second protocol around information being transmitted from said memory system to the host over the host bus, and

4. A method system as recited in claim 1, wherein said memory controller removes an envelope in accordance with the second protocol around information being received at said memory system over the host bus from the host.

5. A memory system as recited in claim 1, wherein the first protocol is MultiMedia Card (MMC) protocol and the second protocol is I²C protocol.

6. A memory system as recited in claim 1, wherein the first protocol is Secure Digital (SD) Card protocol and the second protocol is I²C protocol.

7. A memory system as recited in claim 1, wherein hardware layer of the second protocol is used together with higher layers of the first protocol.

8. A memory system as recited in claim 1, wherein the first protocol is a memory card protocol, and wherein the second protocol is a bus protocol.

9. A memory system as recited in claim 1, wherein said memory controller comprises:
a protocol envelope unit operable to encapsulate communications in accordance with the second protocol for transmission over the host bus and to unencapsulate communications out of the second protocol after being received over the host bus.

10. A memory system as recited in claim 1, wherein said data storage elements provide non-volatile data storage.

11. A memory system as recited in claim 10, wherein said data storage elements provide semiconductor-based data storage.

12. A memory system as recited in claim 11, wherein said data storage elements are EEPROM or FLASH.

13. A memory system as recited in claim 1, wherein said memory system is a memory card.

14. A memory system as recited in claim 1, wherein said memory system is provided within a single package.

15. A memory system as recited in claim 14, wherein the single package is a memory card.

16. A memory system as recited in claim 1, wherein said memory system is a removable data storage product.

17. A memory system as recited in claim 1, wherein the host is a computing device.

18. A memory system as recited in claim 1, wherein said memory system removably couples to the host.

19. A method for communicating electronic signals representative of data or commands over a bus coupled between a host and a memory card, said method comprising:
(a) receiving an incoming envelope at the memory card over the bus in accordance with a bus protocol, the incoming envelope including at least incoming data or commands in accordance with a memory card protocol;
(b) removing the incoming envelope to retain the incoming data or commands; and
(c) thereafter processing the incoming data or commands at the memory card in accordance with the memory card protocol.

20. A method as recited in claim 19, wherein said method further comprises:
(d) identifying outgoing data or commands at the memory card in accordance with the memory card protocol;
(e) placing an outgoing envelope around the outgoing data or commands; and
(f) transmitting the outgoing envelope over the bus in accordance with the bus protocol.

21. A method as recited in claim 20, wherein the memory card protocol is MMC and the bus protocol is I²C.

22. A method as recited in claim 19, wherein the memory card provides non-volatile data storage.

23. A method for transmitting information between a peripheral device and a bus associated with a computing device, said method comprising:
(a) obtaining information to transmit, the information obtained being associated with a first protocol;
(b) adapting the information obtained for transmission in a second protocol; and
(c) transmitting the adapted information over the bus using the second protocol.

24. A method as recited in claim 23, wherein the peripheral device is a memory card.

25. A method as recited in claim 24, wherein the peripheral device is a FLASH memory card.

26. A method as recited in claim 23, wherein the peripheral device is a memory card having non-volatile data storage.
